(19) United States
(12) Patent Application Publication
(10) Pub. No.: US 2012/0137652 A1
(43) Pub. Date: Jun. 7, 2012

(54) Electromagnetic Thrust System

(76) Inventors: Margaret W. Asprey, Las Cruces, NM (US); Robert R. Asprey, La Cruces, NM (US)

(21) Appl. No.: 12/089,512

(22) PCT Filed: Oct. 10, 2006
(86) PCT No.: PCT/US06/39666

§ 371 Date: Aug. 7, 2009

Related U.S. Application Data
(60) Provisional application No. 60/725,028, filed on Oct. 7, 2005.

(51) Int. Cl. F03H 1/00

(52) U.S. Cl. 60/202

(57) ABSTRACT

A method for developing thrust from current flow is disclosed. In a first embodiment, a plurality of loops (201) of wire wound in an asymmetrical pattern is physically connected to a source of electrical power (204), developing thrust in a direction (210). In a second embodiment, a plurality of stationary vanes (306, 307) are provided, and charged with alternating polarity high voltage. A rotor having U-shaped conductors (305) attached thereto rotates the conductors (305) past the vanes. As the rotor turns, an alternating current is electrostatically induced in the legs of the conductors (305), the current generating thrust (304). In two other embodiments, a U-shaped conductive path (405, 506) is inductively coupled to an RF or high frequency power supply in order to generate an alternating current in the conductive paths, thereby generating thrust.

### FIELD OF THE INVENTION

This invention relates to thrust producing systems, and particularly to such a system wherein thrust is generated by interactions of electrons with the quantum-mechanical-vacuum.

### BACKGROUND OF THE INVENTION

A large number of methods for producing thrust have been explored. As far as Applicants are aware, previously disclosed methods all produce thrust by accelerating mass in a direction opposite to the desired thrust in accordance with Newton's third law. In conventional chemical rockets, a rapidly expanding reaction mass developed by an exothermic reaction is constrained, and directed through a constriction nozzle to accelerate the reaction mass to a high speed, thus developing thrust in the opposite direction. In nuclear rockets, the accelerated mass is a gas heated to a high temperature by a nuclear reactor, with the acceleration caused by a pressure increase due to heating the gas where the gas is vented via a constriction nozzle. In the class of thrust devices generally referred to as ion engines, a working fluid, such as xenon gas, is ionized and ions composing the reaction mass are accelerated electromagnetically. The common requirement of all conventional thrust devices is an accelerated reaction mass. Since reaction mass is consumed along with energy these devices are limited in range and life span either by available energy to effect acceleration of the reaction mass, or the amount of mass that can be carried. With current rocket technology, the limiting factor is the quantity of reaction mass available to be used to produce thrust since all of the reaction mass to be used must also be carried out of the Earth's gravity well along with the rocket prior to use. Nuclear rockets have a great deal of energy available and ion thrusters are typically used in space where solar panels are able to provide energy as needed, but both are limited by the amount of reaction mass they can carry.

In the early 1900s most of the present knowledge concerning the forces on and between charged particles and the related electromagnetic fields was developed. The equations of particular relevancy to this invention are known as the Lorentz force equations. A brief description follows where Fg, E, R₁, R₂, U1, U2, R and R̂ are vectors.

F_{g} is the net Lorentz force on the system of the two charges, q₁ and q₂, resulting from the relations between the moving charges, q₁ and q₂ and with the electrostatic field, which is represented by the vector E. R₁, R₂ and U₁, U₂ are respectively the location vectors and velocity vectors for the moving charges q₁ and q₂. F₂₋₁ is the force on q₁ from q₂ as a result of the respective velocities and the separation distance of the two charges given by vector R (=R₂−R₁). Similarly, F₁₋₂ is the force on q₂ from q₁, with the separation distance now given by −R (=R₁−R₂). |R| is the magnitude of the vector R and R̂ is the unit vector along R. The vector cross product operator is denoted by ×. Constants referenced are:

Permittivity of free space: ε₀=8.85*10⁻¹² (Coul²/Nt*m²)

Coulomb Force Constant k=(1/(4*π*ε₀))=8.99*10⁹ (Nt*m²/Coul²)

Permeability of free space: μ=4*π*10⁻⁷ (Weber/(Amp*m))

Speed of light: c²=1/(μ₀*ε₀) (m²/sec²)

E₂₋₁=Electrostatic field at R₁ due to q₂ at R₂

E₂₋₁=(q₂/(4*π*ε₀))*(R₂−R₁)/(|R₂−R₁|)³=>kq₂R̂/|R|²

E₁₋₂=(q₁/(4*π*ε₀))*(R₁−R₂)/(|R₁−R₂|)³=>kq₁R̂/|R|²

Fg=q₁(E₂₋₁+(1/c²)U₁×(U₂×E₂₋₁))+q₂(E₁₋₂+(1/c²)U₂×(U₁×E₁₋₂))

If it is assumed that q₁=q₂=q then q₁*E₂₋₁+q₂*E₁₋₂=0 then

Fg=q*E₂₋₁+(q*(1/c²)U₁×(U₂×E₂₋₁))+q*E₁₋₂+(q*(1/c²)U₂×(U₁×E₁₋₂))q₁*E₂₋₁+q₂*E₁₋₂=0

Which then results in

Fg=(k*q²*|U₁|*|U₂|/(|R|²c²))*(Û₁×(Û₂×R̂)+Û₂×(Û₂×R̂))

Where * denotes scalar multiplication and × denotes the vector cross-product.

Most significantly, Fg is non-zero in the cases where the charges are both moving relative to the reference frame and to each other. This apparent violation of Newton's third law has never been adequately explained. The most common assumption has been that “the electromagnetic field has momentum” (Original edition of Elementary Modern Physics by Weidner & Sells, 1960 Library of Congress catalog number 60-9402). However, Applicants cannot find any scientific basis for or evidence of this assumption—it is purely a result of limiting the definition of the system to the two charges and requiring that momentum be conserved. The inability of the physics community to explain this apparent violation of Newton's third law is seen in the revised edition of the same textbook (Alternate Second Edition of Elementary Modern Physics by Weidner & Sells, 1972, Library of Congress catalog number 72-90874). In the revised edition there is not even a mention of this apparent violation.

Applicants believe the balance of the system relates to the “quantum mechanical vacuum” wherein due to the Heisenberg uncertaincy principle, regardless of how small a region of space within which one considers momentum and position, both cannot be determined precisely. Even in an ideal vacuum, thought of as the complete absence of anything, will not in practice remain empty. English physicist Paul Dirac was the first to propose that empty space (the quantum-mechanical-vacuum) can be visualized as consisting of a sea of electron-positron pairs that can only be released or separated when sufficient energy is made available. More fundamentally, quantum mechanics predicts that quantum-mechanical-vacuum energy can never be exactly zero. The lowest possible energy state is called zero-point energy and may be thought of as of a seething mass of virtual, fundamental particles that have only a brief existence. This is often referred to as “vacuum fluctuation”. In quantum physics, and as a consequence of Werner Heisenberg's uncertainty principle, a quantum fluctuation is a temporary change in the amount of energy in a point in space, such as would be developed by a moving charged particle such as an electron. According to one formulation of the principle, energy and time can be related by the relation:

$$Δ E Δ t \approx \frac{h}{2 π}$$

Where h is Plank's constant (6.626×10⁻³⁴ Joule-second).

This means that conservation of energy can appear to be violated, but only for very short times. This allows the creation of particle-antiparticle pairs of virtual particles that are constantly forming and destroying each other around a moving electron, their creation facilitated by energy exerted by the electron charge against the quantum-mechanical vacuum. The effects of these virtual particles are measurable, for example in the effective charge of the electron, which when modified by particle-antiparticle pairs of virtual particles surrounding the electron, is different from its “naked” charge, which does not include the quantum-vacuum cloak of virtual particles.

One popular description of the quantum-mechanical-vacuum is that a particle and the associated anti-particle wink into existence for a very short time period then annihilate each other. This is a continuing process, and occurs throughout space down to subatomic size regions Applicants believe that an interaction occurs when particle-antiparticle pairs of the quantum-mechanical vacuum are acted upon by Lorentz forces, generated by other moving charges that imparts changes in momentum to the momentarily-created, charged particle-antiparticle pairs of the “empty” quantum-mechanical vacuum prior to their self-annihilation. This interaction causes a momentum transfer to occur, with the fabric of space-time absorbing the change of momentum. The ability of a hard vacuum (containing only the “quantum-mechanical-vacuum”) to push conductive plates together was predicted in 1948 by Dutch theoretical physicist Hendrik Casimir and demonstrated in 1958 by Marcus Spaarnay at Philips in Eindhoven, who measured the so-called Casimir force between two flat, metallic mirrors.

In accordance with the foregoing, it is the primary object of this invention to provide conductive shapes optimized for utilizing what is believed to be a change in momentum to the momentarily-created, charged particle-antiparticle pairs of an “empty” quantum-mechanical vacuum by effects of a moving charged particle prior to self-annihilation of the pairs. Such optimized shapes eliminate need to provide reaction mass in order to produce thrust, the thrust being developed by the interaction of moving charges and particle-anti-particle pairs. Other objects of the invention will become apparent upon a reading of the following specification.

### BRIEF DESCRIPTION OF THE DRAWINGS

FIG. 1 is a diagrammatic view of the basic Lorentz force definition.

FIG. 2 depicts the low voltage, closed loop preferred embodiment of the Asymmetric Lorentz Thrust generation device.

FIG. 3 depicts the high voltage induced current embodiment of the Asymmetric Lorentz Thrust generation device.

FIG. 4 depicts the induced “antenna current” embodiment of the Asymmetric Lorentz Thrust generation device.

FIG. 5 depicts the geometric tuned circuit embodiment of the Asymmetric Lorentz Thrust generation device.

FIG. 6 depicts a Cavendish like balance system used to test Applicants Asymmetric Lorentz Thrust generation device.

FIG. 7 depicts a floating, magnetically centered, system used to test Applicants Asymmetric Lorentz Thrust generation device.

### DETAILED DESCRIPTION OF THE DRAWINGS

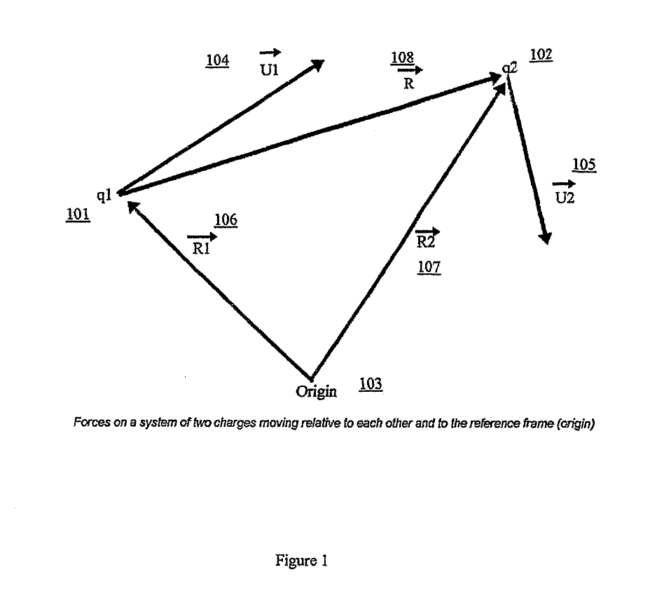

The basic principle of operation of the present invention involves providing a series of moving charges through a conductor formed in a pattern such that not all of the resulting Lorentz forces are cancelled out by symmetry. In the broadest concept of the invention, and as shown in FIG. 1, moving charges q1 101 and q2 102 are moving with velocities U1 104 and U2 105, respectively. Position vectors R1 106 and R2 107 define locations of charges q1 101 and q2 102. Relative position vector R 108 is the vector difference between R2 107 and R1 106. Moving charges generate magnetic fields and also interact with magnetic fields. Also, all charges generate electrostatic fields and also interact with electrostatic fields. The Lorentz forces are the superposition of the forces due to static (electric) fields and dynamic (magnetic) fields. For a system modeled as two isolated charges, the static (electric) field interaction with the particles are always equal in magnitude and opposite in direction and thus cancel out. Dynamic (magnetic) interactions are controlled by the sizes of the charges, velocities (magnitude and direction) and separation of the charges, and do not always sum to zero as do the static (electric) interactions.

Systems consisting of more than two charges can be analyzed by using the principle of superposition and calculating the net force vectors for each pair of charges and summing the vectors to yield a total net force vector.

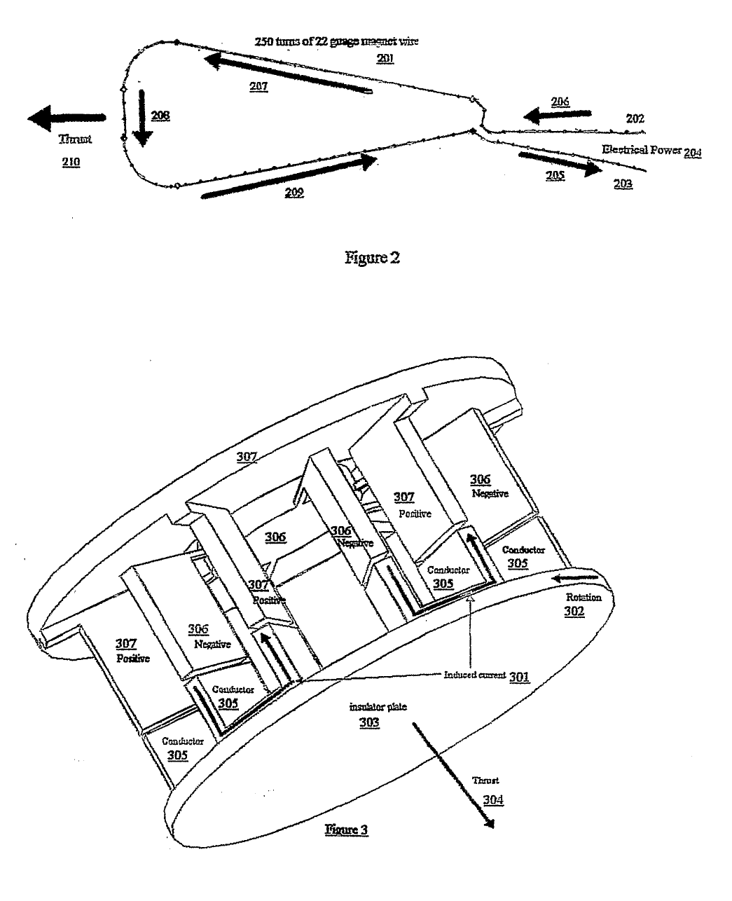

The basic principle of operation of the present invention involves generating a system of moving charges wherein the net force vector for the system is of non-zero magnitude. FIG. 2 illustrates, by way of example, one possible embodiment of a physically asymmetrical device that achieves a non-zero net thrust due to Fg not summing to zero as described in the above equation. The device is composed of magnet wire, with current applied from electrical power source 204 via a single strand 202. The magnet wire is formed into a bundled multiple-turn asymmetrical loop 201 having about 250 loops of magnet wire, with the distal portion of the loop (with respect to the power supply) being enlarged with two radii and a generally straight portion between the radii, and the proximal portion of the loop having a single radius smaller than the distal radii. Current is returned via a single strand of magnet wire 203 to electrical power source 204. The current flow in the loop is depicted by arrows 207, 208 and 209. This configuration has been tested with both AC and DC current, and generates a net thrust 210 along the horizontal axis towards the large end. The tests were conducted in a draft-blocking cage (not shown) wherein spurious air currents were blocked, and utilizing two mechanisms. It is believed that electrons changing direction along the radii at the distal end of loop 201 causes the net forces of the system to be non-zero. It may also be that only a single change of direction along one radius may be all that is needed to generate a net non-zero force. Here, the change in direction may be forced by a chevron-shaped or L-shaped conductive path. Further yet, the more abrupt a change in direction an electron is forced to make is believed to generate a stronger net non-zero force. As such, a large number of tiny conductive paths configured as chevrons, configured as L-shaped paths or a path configured as a particularly sized radius, and all oriented in the same direction, may generate relatively large net forces.

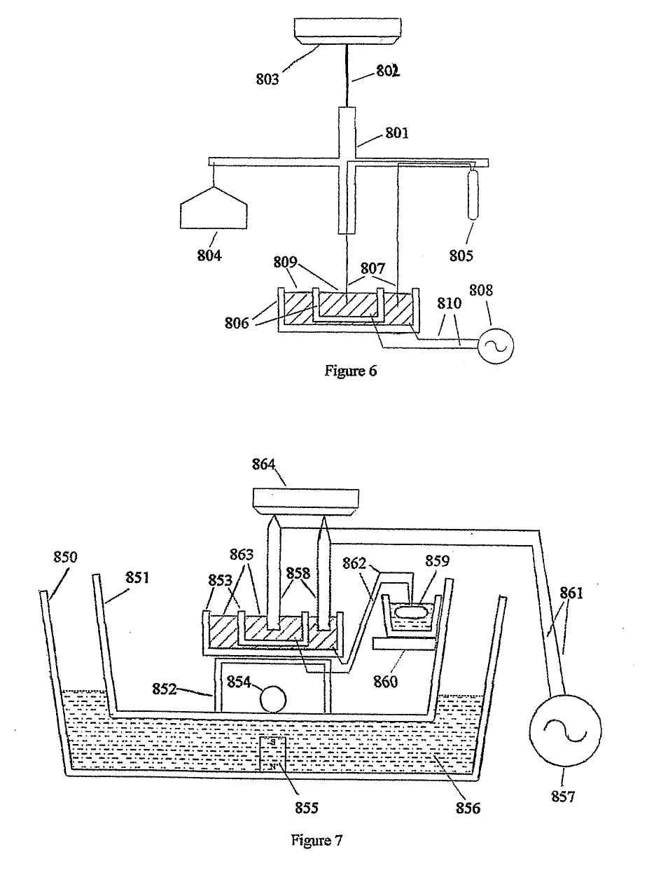

FIG. 6 depicts a first test rig that consists of a unit similar in structure to a Cavendish balance. A frame 801 is suspended from a fixed support 803, illustrated as a mechanical ground, by a Kevlar™ thread 802. The unit 805 under test is suspended on one arm of frame 801 and is counter-balanced by counterweight 804. Alternating current from a 60 Hz source 808 is delivered to the unit under test 805 by conductor leads 807 suspended in a conductive liquid 809, such as mercury or salt water, contained in electrically isolated, co-axial transfer containers 806. The wires 810 from A/C source 808 are in electrical contact with conductive liquids 809. The unit under test 805 is oriented to provide a torsion in Kevlar thread 802. The angle of rotation, with A/C power source 808 energized, is directly related to the thrust produced. As a displacement angle beyond 360 degrees (2 pi radians) cannot be achieved with static fields, the possibility that an external magnetic field caused the observed rotation is eliminated. In this embodiment, the unit under test weighed approximately one kilogram, and received about 30 watts of power at 2 amperes current, and turned 10-12 turns before equilibrium was reached with the fixed Kevlar™ string.

The other test system, as shown in FIG. 7, also in the draft-blocking cage (not shown), consists of a plastic tub float 851 floating in water 856 contained by plastic tub 850. A permanent magnet 855 attracts steel ball 884 causing float 851 to remain centered without inducing any torsion on float 851. Electrically isolated, coaxial, transfer containers 853 are filled with a conductive fluid, again such as mercury or salt water, and mounted on stand 852 such that the coaxis is vertical and is in line with the center of steel ball 854. Wire transfer leads 858 are suspended from fixed stand 864 and in contact with conductive liquid 863 contained in the coaxial transfer containers 853. A/C power source 857 supplies power via leads 861 to wire transfer leads 858. Wires 862 electrically in contact with the conductive liquids 863 bring power to the unit under test 859, which is immersed in a water bath 856 attached to float 851 in order to distribute heat generated in the unit under test 859 to prevent thermal currents. In this embodiment, the unit under test weighed 4-5 kilograms, and without constraints of the string, rotated continuously as long as electrical power was applied. This unit under test rotated in the water with currents as small as 100 milliamps.

Mathematical models of the system predict the resulting net thrust. To create the model, the current loop is assumed to contain moving charges. The charges are modeled as point charges of magnitude equal to the current times the separation distance of the points. Velocity is assumed to be tangent to the loop at the point, and the distance is the vector differences between points based on a fixed origin. The force calculation is done for each point paired to every other point in the loop and the vector result summed. Applicants believe that multiple separate windings can be designed to interact as a multiplier. In a miniaturized environment, Applicants believe this can be achieved by using modern manufacturing methods to place a large number of microscopic loops, chevron shaped conductive paths or L-shaped conductive paths on a substrate. Microscopic nested loops may also provide significant non-zero forces. Applicants also believe that utilization of superconductor technology will enhance performance.

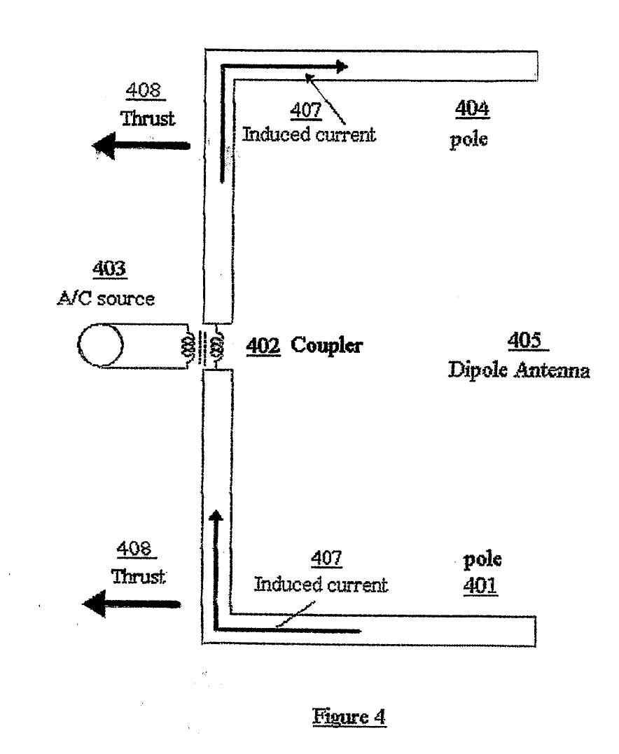

FIG. 3 depicts a high voltage, electrostatically induced current embodiment of the Asymmetric Lorentz Thrust generation device that is asymmetric in time, meaning that asynchronous electrical flows are induced in a single conductor. In this embodiment, there is a fixed inner disk 306 and an outer annular disk 307, these disks being of a conductive material and electrically insulated from each other. A plurality of conductive plates or vanes alternately connect to disks 306 and 307, with vanes 306 connected to the inner disk and vanes 307 connected to the outer, annular disk. A high voltage DC power supply (not shown) may be conventionally coupled to provide a high voltage electrical potential between disks 306 and 307, thus applying a high electrical potential between the vanes. A rotor is rotatably mounted in coaxial relation adjacent disks and vanes 306 and 307, and includes an insulative plate 303, with electrically isolated, generally U-shaped conductor blocks 305 of a conductive material bonded or attached to plate 303. The upper ends of each U-shaped conductor block are in spaced relation with respect to each other such that they may be aligned as shown with two consecutive vanes 306, 307 of opposite polarity. Gaps between ends of the arms of the conductor blocks 305 and vanes 306, 307 is sufficiently large so as to prevent arcing between the conductor blocks and the energized vanes 306, 307 as the rotor is turned, as indicated by arrow 302, but sufficiently small so as to induce relatively large current flows in the conductor blocks. In some embodiments where the amount of generated thrust is varied by rotational speed of the rotor, this distance may be varied, as by apparatus (not shown) that senses rotational speed and widens or reduces the space with increasing or decreasing rotational speeds, depending on potentials of the induced current flows. In other embodiments where the rotational speed is set, the gap may be increased or decreased to increase or decrease induced current flows, thus varying thrust produced. In yet other embodiments the high voltage potential may be varied in order to vary thrust.

Operation of this embodiment is such that applied high voltages may be from 500-1000 volts or more, with rotation of the rotor being set at a fixed rotation, such as 250-750 RPMs or so, or adjustable up to a rotational speed where induced current flows in the conductor blocks can no longer occur, or up to a rotational speed limited by structural components of the rotor. During rotation of the rotor, the arms of the conductor blocks 305 first align with the leading negative edge 306 and the trailing positive edge 307, inducing current 301 as shown by the arrow. As the rotor continues to turn, the leading edge of the conductor blocks 305 approach the next set of positive and negative vanes 306, 307, causing the induced current 301 to reverse and flow in the opposite direction. As such, direction of the current induced by high voltage electrostatic fields in each conductor block is caused to rapidly alternate in direction. There is no current flow between the conductor blocks 305 and either the positive vane 307 or negative vane 306. Since the currents in the conductor blocks do not complete a circuit, but simply alternate direction, there will be a net Lorentz force generated that is shown as thrust 304. This embodiment would be useful in spacecraft or other applications where the rotor is sufficiently massive or operates at such a high RPM to also serve as a stabilizing gyroscope, with thrust developed as needed by intermittent application of electrical potential or a varying electrical potential. As also should be apparent, the device may be mounted in a gimbal arrangement so that both thrust and stabilizing forces of the rotor-gyroscope may be controllably directed.

While these embodiments are based on a rotary system, it should be apparent that linear systems should work as well. Here, a linear array of alternately charged vanes, plates or poles may be arranged in conjunction with a conveyer belt-type system having the movable U-shaped conductors attached thereto that moves the U-shaped conductors past the linearly arranged vanes in order to induce an alternating current between legs of the U-shaped conductors. The only critical feature here is development of the alternating current between the legs of the U-shaped conductors.

FIG. 4 depicts a dipole antenna-shaped induced current embodiment of Applicants asymmetric Lorentz thrust generation apparatus. In this embodiment, there are two generally L-shaped fixed conductors or poles 401 and 404 forming the dipole assembly 405. These poles may be constructed of plates, vanes or wires, or any other conductive material. The dipole 405 is coupled inductively via an inductive coupler 402, which may be a transformer winding, to an A/C source 403 that ideally has a wavelength tuned to the dipole 405. Such a wavelength may be a sine wave, a square wave, sawtooth or any other alternating signal that induces current into the dipole. When such a signal from the A/C source 403 is applied to coupler or transformer winding 402, alternating induced currents 407 are developed in the poles 404 and 401. As the A/C signal changes polarity the induced currents 407 reverse direction. As with the embodiments of FIG. 3, the currents do not complete a circuit, developing a net Lorentz force that manifests itself as thrust 408. Such an embodiment may also be used in a spacecraft or satellite wherein the dipole is mounted to a gimbal platform so that thrust may be directed in any direction. As such, for attitude maintenance, only one of Applicants Asymmetric Lorentz Thrust generation dipoles may be required rather than three-gyroscope systems as currently used today, although less mechanically complex systems using any plurality of fixed such dipole thrust systems may be used.

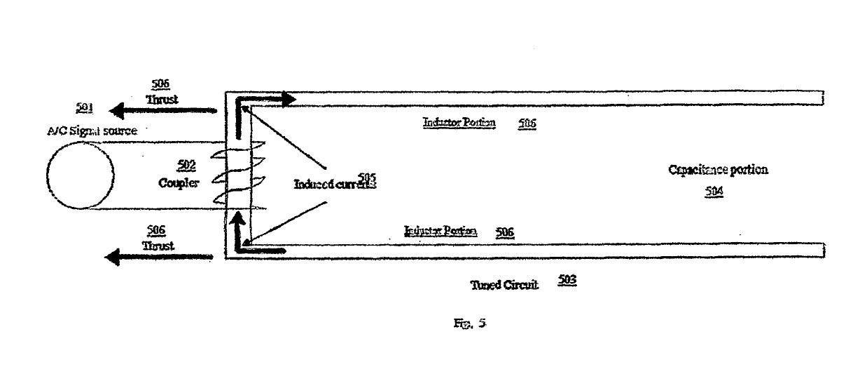

FIG. 5 depicts an elongated generally U-shaped geometric tuned circuit embodiment of the Asymmetric Lorentz Thrust generation device wherein a U-shaped inductor 506 forms the inductor portion of a tuned circuit 503. Again, the U-shaped inductor portion may be in the form of wires, plates or poles, and be of any conductive material. The legs or inductor portions 506 also serve as capacitor plates for the capacitance portion 504. The tuned circuit 503 is inductively coupled via a coupler 502, which again may be a transformer winding, to an A/C signal source 501. When a signal at the resonant frequency of the tuned circuit 503 from the A/C source 501 is applied to coupler 502, induced currents 505 are developed in the poles 506 that alternately charge and discharge capacitance portion 504 at the resonant frequency of the inductor portion and capacitance portion. The induced currents 505 represent an A/C current. Since the currents 505 do not complete a circuit, a net Lorentz force is developed that is manifested as thrust 506. Like the embodiment of FIG. 4, the geometric tuned circuit embodiment may be mounted to a gimbal platform on a spacecraft so that thrust may be directed in any desired direction.

While L-shaped and U-shaped conductors are disclosed in the above embodiments, it should be apparent that modified L-shaped or U-shaped conductive paths may be employed wherein the L-shape is at a somewhat greater than 90 degree angle or less than 90 degree angle, as generally shown in FIG. 2, and that the L-shaped portions of U-shaped conductive paths may be similarly altered in order to optimize the net non-zero forces as described above. Also as noted above, only a single change of direction of an electron flow may provide significant useful forces.

As also should be apparent, since there is no mass ejecta from any of Applicants thrust producing devices, they may be mounted anywhere to an interior or exterior of a spacecraft, or to any toy or other device that may benefit from or utilize thrust or forces developed thereby. This includes miniaturized devices, which as stated may be in the form of integrated circuits. Such smaller devices may have applications in medical research where it is desired to move or manipulate individual cells, proteins or other minute particles. This may be achieved due to development of movement of a conductive fluid, such as water containing electrolytes, or biological fluids, within which a thrust-producing apparatus is immersed. Further, the conductor shapes may be created using wires, coils or plates of any conductive or semiconductive material that permits electron flow therethrough, or even enclosures containing an ionizable gas similar to shaped fluorescent or neon lights that permit electron flow.

Having thus described my invention and the manner of its use, it should be apparent to those skilled in the relevant arts that incidental changes may be made thereto that fairly fall within the scope of the following appended claims, wherein

I claim:

1. Apparatus for generating thrust comprising:
a source of electrical power (204, 306, 307, 403, 501),
at least one conductor (201, 305, 402, 407, 506) coupled to said source of electrical potential,
said conductor (201, 305, 402, 407, 506) having a geometry configured so as to force electron flow therethrough to make at least one change of direction to generate Lorentz forces that may be used as thrust when energized by said electrical power.

2. Apparatus as set forth in claim 1 wherein said conductor is a tiny conductor, with a plurality of tiny conductors mounted in an orientation so as to produce said thrust in one direction.

3. Apparatus as set forth in claim 1 wherein said conductor is a wire (201), and said change of direction is in the form of an asymmetrical coil (201).

4. Apparatus as set forth in claim 1 wherein said source of electrical power comprises a plurality of vanes (306, 307), with an electrical power supply connected to provide an electrical potential of an opposite polarity to each successive vane (306, 307) of said plurality of vanes (306, 307), and said conductor further comprises a plurality of generally U-shaped conductors (305) disposed for movement past said plurality of vanes (306, 307) so that legs of said generally U-shaped conductors (305) are alternately and electrostatically charged by said electrical potential of opposite polarity, developing said Lorentz forces that may be used as, thrust.

5. Apparatus as set forth in claim 1 wherein said source of electrical power further comprises an AC electrical source (403) coupled to an inductive coupler (402), and said conductor comprises two generally L-shaped conductors (401, 404) arranged as a dipole with said inductive coupler (402) connected between said generally L-shaped conductors (401, 404) in order to alternately and inductively charge said generally L-shaped conductors (401, 404) from said AC electrical source (403), thereby inducing Lorentz forces that may be used as thrust.

6. Apparatus as set forth in claim 5 wherein said AC electrical source (403) provides electrical energy at a wavelength tuned to said dipole (401, 404) in order to induce an alternating current in said generally L-shaped conductors.

7. Apparatus as set forth in claim 1 wherein said conductor is an elongated, generally U-shaped inductor ((506), with said electrical power applied to a coil (502) wrapped around said inductor (506) between legs of said inductor.

8. Apparatus as set forth in claim 7 wherein said generally U-shaped inductor (506) is the inductor portion (506) of a tuned circuit wherein end regions of said legs also form a capacitance portion (504) for the tuned circuit, and said electrical power is a signal at a resonant frequency of said tuned circuit.

9. A method for developing thrust from Lorentz forces comprising:
providing a source of electrical power (204, 306, 307,403, 501),
providing a conductive path (201, 305, 401, 404, 506) of a shape to force electron flow therethrough to make an abrupt change in direction to develop said Lorentz forces,
coupling said source of electrical power to said conductor so as to to develop said Lorentz forces.

10. A method as set forth in claim 9 wherein said providing a conductive path of a shape to force electron flow therethrough to make an abrupt change in direction to develop said Lorentz forces further comprises providing a conductor (201) that is wound in an asymmetrical pattern, and connecting said source of electrical power (204) to said conductor to generate said thrust.

11. A method as set forth in claim 9 wherein said providing a conductive path of a shape to force electron flow therethrough to make an abrupt change in direction to develop said Lorentz forces further comprises providing a generally U-shaped conductor (305), and electrostatically coupling said source of electrical power (306, 307) to said generally U-shaped conductor to generate said thrust.

12. A method as set forth in claim 11 wherein said electrostatically coupling said source of electrical power (306, 307) to a generally U-shaped conductor (305) further comprises moving a plurality of generally U-shaped conductors (305) past a succession of vanes (306, 307) each charged with an electrical potential of opposite polarity with respect to a preceding or following vane of said plurality of vanes to generate said thrust.

13. A method as set forth in claim 12 further comprising mounting said succession of said vanes (306, 307) in a circular arrangement, with a rotor rotatably supporting said plurality of generally U-shaped conductors (305) so that ends of said generally U-shaped conductors (305) are circularly rotated in close proximity past ends of said succession of vanes (306, 307), thereby inducing an alternating current flow between legs of each of said generally U-shaped conductors (305) to generate said thrust.

14. A method as set forth in claim 9 wherein said coupling said source of electrical power to said conductor further comprises inductively coupling (402) an AC signal between a pair of generally L-shaped dipoles (401, 404) connected to provide a generally U-shaped conductive path, said AC signal tuned to said dipole to induce an alternating current in said dipole.

15. A method as set forth in claim 9 wherein said coupling said source of electrical power further comprises inductively coupling (502) an AC signal between legs of an elongated, generally U-shaped conductor (506) wherein said generally U-shaped conductor forms part of a tuned circuit and said electrical potential is a signal at a resonant frequency of said tuned circuit.

16. A method as set forth in claim 9 further comprising sizing said conductive path to be a tiny said conductive path, and mounting a large number of tiny conductive paths in an orientation to produce a non-zero force in one direction.
